(19) United States
(12) Patent Application Publication
(10) Pub. No.: US 2007/0132680 A1
(43) Pub. Date: Jun. 14, 2007

(54) Image display apparatus

(75) Inventors: Shuichi Kagawa, Tokyo (JP); Jun Someya, Tokyo (JP); Hiroaki Sugiura, Tokyo (JP)

Correspondence Address: BIRCH STEWART KOLASCH & BIRCH, PO BOX 747, FALLS CHURCH, VA, 22040-0747, US

(73) Assignee: Mitsubishi Electric Corporation

(21) Appl. No.: 11/636,473

(22) Filed: Dec. 11, 2006

(30) Foreign Application Priority Data
Dec. 12, 2005 (JP) 2005-357524

(51) Int. Cl. G09G 3/34

(52) U.S. Cl. 345/84

(57) ABSTRACT

A field-sequential display apparatus having a light source that emits light of different colors in different subframes of an image controls the spectral distribution of the light emitted in each subframe according to characteristics of the input image data, or to ambient conditions or other user-specified conditions. The input image data are processed so that image colors are displayed correctly despite changes in the spectral distribution of the light-source colors. This scheme enables the gamut of reproducible colors to be altered from frame to frame to provide an appropriate balance between brightness and color saturation in each frame, and to compensate for ambient lighting conditions.

### BACKGROUND OF THE INVENTION

1. Field of the Invention

The present invention relates to image display apparatus, more particularly to a field-sequential image display apparatus that displays color images by using a light source and a light valve.

2. Description of the Related Art

An exemplary field-sequential image display apparatus using a light source and a light valve is disclosed in Japanese Patent Application Publication No. 2000-199886. The light source includes red, green, and blue light emitters, which are turned on sequentially, one at a time. The light valve is a liquid crystal panel, which is controlled according to the red, green, or blue component of the current image frame. The apparatus displays successive red, green, and blue subframes; human vision integrates the subframes and perceives a full-color image. This method of display eliminates the need to divide each picture element (pixel) on the liquid crystal panel into red, green, and blue subpixels and thereby enables the image to be displayed with higher definition.

In this conventional display apparatus, however, since the light emitter of each color emitter is lit for, at most, only one-third of the display time, the apparatus is unsatisfactory when high brightness is required. It is possible to improve the brightness of the display by increasing the emission intensity of the light emitters or by increasing the number of emitters of each color, but the former strategy is limited by the opto-electrical characteristics of the light emitters, and the latter strategy raises problems of size and cost.

Another problem is that since the gamut of reproducible colors is always the same, the apparatus cannot take advantage of the characteristics of the input image data, or adjust optimally to ambient conditions. For example, an image may consist only of colors with high saturation, or only of colors with low saturation, but the same gamut of reproducible colors is used for both types of images.

Similar problems occur in image display apparatus using other types of light valves, such as digital light processing (DLP) apparatus using microelectromechanical light valves.

### SUMMARY OF THE INVENTION

An object of the present invention is to obtain an image display apparatus capable of flexibly adjusting a balance between maximum brightness and gamut of reproducible colors depending on characteristics of input image data and the conditions of usage of the image display apparatus, and displaying a color image with the appropriate balance.

The invented image display apparatus is a field-sequential apparatus that receives image data divided into frames and subdivides each frame into a plurality of subframes. The apparatus includes a light source that can output light with different spectral distributions in each subframe of the frame. A control unit controls the spectral distribution of the light in each subframe according to control information. A subframe image data generating means processes the input image data to generate subframe image data suitable for the spectral distribution of the light output by the light source in each subframe. A light valve modulates the light output by the light source, pixel by pixel, according to the subframe image data.

The control information may include information about a characteristic of the input image data, such as the brightness or saturation of the colors in each frame. The control information may also include information about usage conditions such as ambient lighting or a user-specified display purpose. The invention enables the image display apparatus to operate with a good balance between image brightness and the gamut of reproducible colors, suitable for the input image data and the conditions of use.

### BRIEF DESCRIPTION OF THE DRAWINGS

In the attached drawings:

FIG. 1 is a block diagram illustrating an image display apparatus in a first embodiment of the invention;

FIGS. 2A and 2B are graphs showing exemplary relationships between a frame synchronizing signal (FS) and subframe synchronizing signal (SS);

FIG. 3 is a block diagram showing an exemplary internal structure of the emission ratio control means in FIG. 1;

FIGS. 4A to 4C, 5A to 5C, and 6A to 6C are graphs showing exemplary emission intensities of the emitters in each subframe;

FIG. 7 is an x-y chromaticity diagram illustrating exemplary gamuts of reproducible colors in the image display apparatus in the first embodiment;

FIG. 8 is a graph illustrating exemplary saturation and brightness of display colors in the image display apparatus in the first embodiment;

FIG. 9 is a block diagram illustrating an exemplary internal structure of the subframe image data generating means in FIG. 1;

FIG. 10 is a block diagram illustrating another exemplary internal structure of the subframe image data generating means in FIG. 1;

FIG. 11 is a block diagram illustrating an image display apparatus in a second embodiment of the invention;

FIG. 12 is a block diagram showing an exemplary internal structure of the characterizing information detection means in FIG. 11;

FIG. 13 is a block diagram showing another exemplary internal structure of the characterizing information detection means in FIG. 11;

FIG. 14 is a graph showing an exemplary histogram generated in the histogram generating means in FIG. 13;

FIG. 15 is a block diagram showing an exemplary internal structure of the subframe image data generating means in FIG. 11;

FIG. 16 is a block diagram showing still another exemplary internal structure of the characterizing information detection means in FIG. 11;

FIG. 17 is a block diagram showing yet another exemplary internal structure of the characterizing information detection means in FIG. 11;

FIGS. 18A to 18C are graphs showing exemplary emission intensities of the emitters in each subframe;

FIG. 19 is a block diagram showing another exemplary internal structure of the subframe image data generating means in FIG. 11;

FIG. 20 is a block diagram illustrating an image display apparatus in a third embodiment of the invention;

FIG. 21 shows an exemplary menu in the usage condition specification means in FIG. 20;

FIG. 22 shows another exemplary menu in the usage condition specification means in FIG. 20;

FIG. 23 shows yet another exemplary means that may be used to specify usage conditions; and

FIG. 24 is a block diagram illustrating an image display apparatus in a fourth embodiment of the invention;

### DETAILED DESCRIPTION OF THE INVENTION

Embodiments of the invention will now be described with reference to the attached drawings, in which like elements are indicated by like reference characters.

### First Embodiment

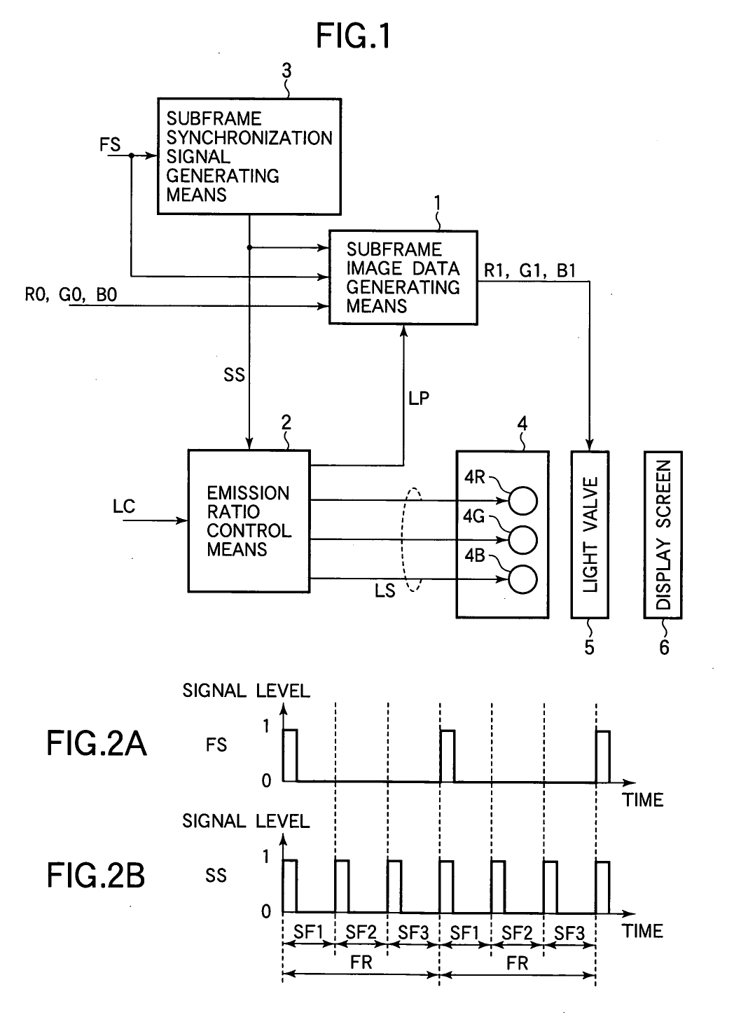

Referring to FIG. 1, the first embodiment is an image display apparatus comprising a subframe image data generating means 1, an emission ratio control means 2, a subframe synchronization signal generating means 3, a light source 4, and a light valve 5. The light source 4 comprises three light emitters 4R, 4G, 4B.

The image display apparatus receives input image data R0, G0, B0, control information LC, and a frame synchronization signal FS. The frame synchronization signal FS indicates the start of each frame of the image. The input image data R0, G0, B0 indicate the magnitudes of the red, green, and blue components of each pixel in each frame. The control information LC is derived from characteristics of the input image data or conditions under which the image display apparatus is used. The emission ratio control means 2 uses the control information LC to control the emission intensities of the light emitters 4R, 4G, 4B.

The subframe synchronization signal generating means 3 receives the frame synchronization signal FS and generates a subframe synchronization signal SS. In FIGS. 2A and 2B, exemplary relationships between the frame synchronization signal FS and the subframe synchronization signal SS are shown, the horizontal and vertical axes indicating time and signal level, respectively. The frame synchronization signal FS and subframe synchronization signal SS are binary signals taking values of ‘0’and ‘1’. The period from one rising edge to the next rising edge in the frame synchronization signal FS is defined as one frame period FR, and the image data input during this period become the image data for the relevant frame. In the image display apparatus of the present embodiment, the subframe synchronization signal generating means 3 divides each frame period into three subframe periods SF1 to SF3, and generates the subframe synchronization signal SS in synchronization with each of the subframe periods SF1 to SF3. The proportions of the subframe periods SF1 to SF3 in one frame period need not be uniform. The generated subframe synchronization signal SS is supplied to the subframe image data generating means 1 and emission ratio control means 2.

The light emitters 4R, 4G, 4B in the light source 4 emit red, green, and blue light, respectively. The light from the light source 4 is a combination of the light from the light emitters 4R, 4G, and 4B, and has a spectral distribution that varies depending on the emission ratio of the light emitters 4R, 4G, 4B. In synchronization with the subframe synchronization signal SS, the emission ratio control means 2 generates emission intensity control signals LS controlling the emission intensities of the light emitters 4R, 4G, 4B in each subframe, and supplies them to the respective light emitters 4R, 4G, 4B. The emission ratio of the three light emitters is controlled on a per-subframe basis according to the information in these emission intensity control signals LS, which is derived from the control information LC.

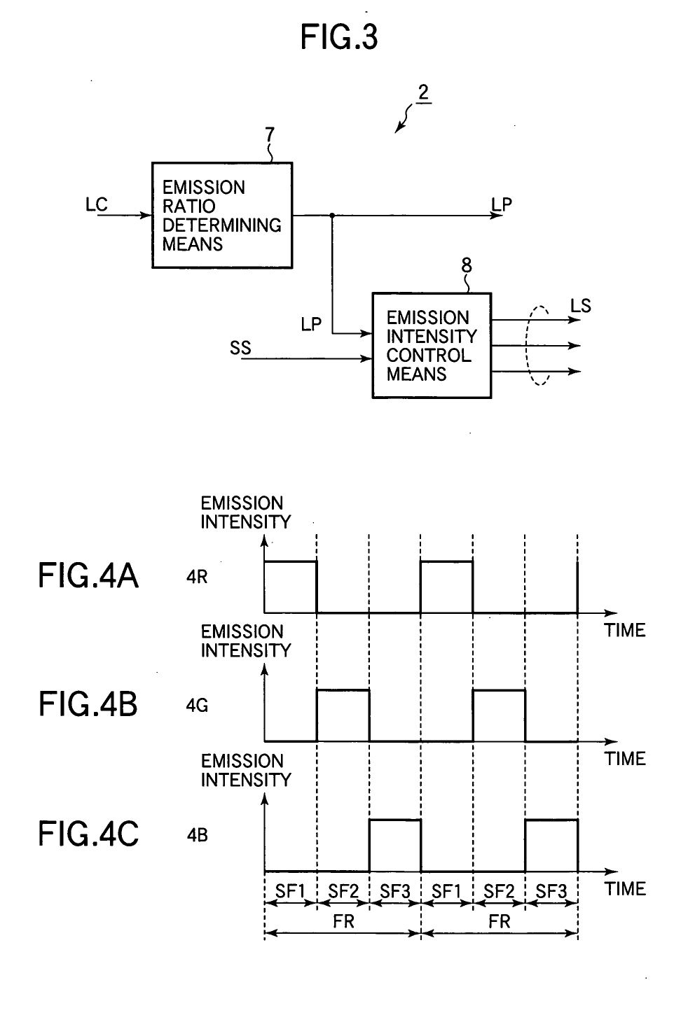

Referring to FIG. 3, the emission ratio control means 2 comprises an emission ratio determining means 7 and an emission intensity control means 8. The emission ratio determining means 7 receives the control information LC, determines the emission ratio of the three light emitters in each subframe, and outputs it as emission ratio information LP. The emission intensity control means 8 receives the emission ratio information LP and subframe synchronization signal SS, determines the emission intensities of the three light emitters in each subframe from the emission ratio information LP, and supplies corresponding emission intensity control signals LS to the three light emitters in synchronization with the subframe synchronization signal SS. In the image processing apparatus in this embodiment, the light source 4 comprises light emitters 4R, 4G, 4B for three colors, but there is no restriction on the number of colors, provided the light source 4 can emit light having a different spectral distribution in each subframe; there may be only two colors, or there may be four colors or more. If the number of colors is changed, the structure of the emission ratio control means 2 for controlling the spectral distribution of the light output from the light source 4 should be changed accordingly.

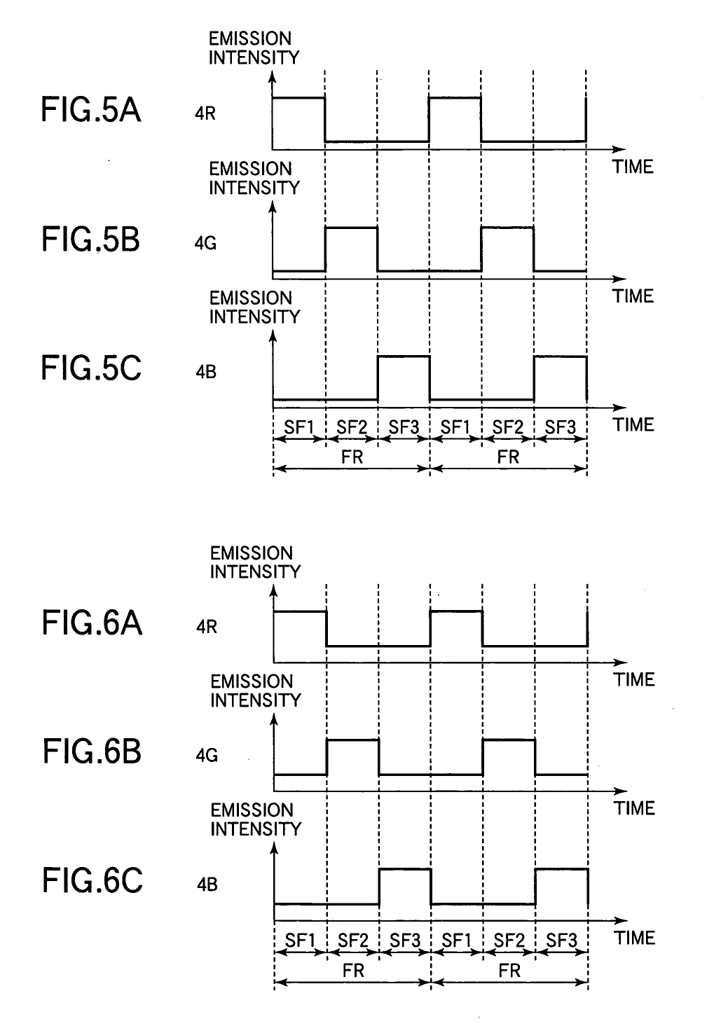

FIGS. 4A-4C, 5A-5C, and 6A-6C are graphs showing exemplary emission intensities of the light emitters 4R, 4G, 4B in each subframe; the vertical axis indicates the emission intensity of an emitter and the horizontal axis indicates time. As shown in the drawings, a frame FR includes three subframes: a first subframe SF1, a second subframe SF2, and a third subframe SF3, in sequence from the start of the frame. In the example in FIGS. 4A-4C, light is emitted only by light emitter 4R in the first subframe SF1, only by light emitter 4G in the second subframe SF2, and only by light emitter 4B in the third subframe SF3. In the examples in FIGS. 5A-5C and 6A-6C, however, the light emitters of all three colors emit light in all subframes. The differences in the emission ratio in each subframe is smaller in FIGS. 6A-6C than in FIGS. 5A-5C. In the first subframe SF1, for example, among the three light emitters, light emitter 4R emits the most light in all three examples (FIGS. 4A-4C, FIGS. 5A-5C, and FIGS. 6A-6C), with light emitters 4G, 4B emitting more light in FIGS. 6A-6C than in FIGS. 5A-5C and emitting no light at all in FIGS. 4A-4C. Therefore, the differences in the emission ratio in subframe SF1 are greatest in FIGS. 4A-4C and smallest in FIGS. 6A-6C. The differences in the emission ratio of the light emitters 4R, 4G, 4B are related to the color purity of the light emitted from the light source 4; the larger the differences in the emission ratio are, the higher the color purity of the light from the light source 4 becomes, so that colors with higher saturation can be displayed. The differences in the emission ratio of the three light emitters can be varied on a per-subframe basis.

The subframe image data generating means 1 receives the input image data R0, G0, and B0, the frame synchronization signal FS, the emission ratio information LP from the emission ratio control means 2, and the subframe synchronization signal SS from the subframe synchronization signal generating means 3. The subframe image data generating means 1 estimates, with reference to the emission ratio information LP, the saturation characteristics of the light from the light source in each subframe, and generates suitable subframe image data R1, G1, B1 for the relevant subframe from the input image data R0, G0, B0. The subframe image data R1, G1, B1 are supplied to the light valve 5 in synchronization with the subframe synchronization signal SS. The light valve 5 modulates the light from the light source 4 on a pixel-by-pixel basis according to the values of the subframe image data R1, G1, and B1, and displays the image on a display screen 6. The light valve 5 comprises, for example, a liquid crystal panel of the reflection type or transmission type. In the case of a digital light processing (DLP) display apparatus, the apparatus comprises a digital micromirror device (DMD).

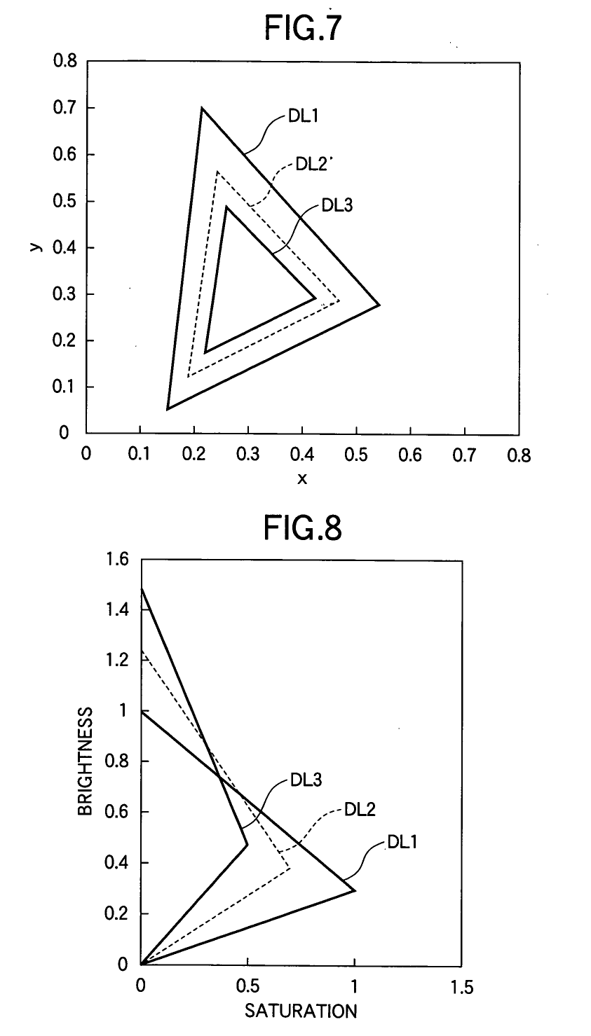

FIG. 7 is an x-y chromaticity diagram illustrating exemplary gamuts of reproducible colors in the image display apparatus of this embodiment. FIG. 7 shows three gamuts of reproducible colors: gamut DL1 results from a large difference in the emission ratio of the light emitters in each subframe as in FIGS. 4A-4C, gamut DL2 results from a medium difference as in FIGS. 5A-5C, and gamut DL3 results from a comparatively small difference as in FIGS. 6A-6C. That is, the gamut of reproducible colors varies depending on the size of the differences in the emission ratio of the light emitters in each subframe: the larger the differences are, the wider the gamut becomes.

FIG. 8 is a graph illustrating exemplary saturation and brightness of colors displayed by the image display apparatus in the first embodiment for the color red. A value obtained by normalizing the distance from the white point on the x-y chromaticity diagram is employed as the saturation value, and a value obtained by normalizing the luminance value is employed as the brightness value. FIG. 8 shows examples of displayed saturation and brightness for the cases when the differences in the emission ratio of the three light emitters in each subframe are large (DL1), medium (DL2), and small (DL3), corresponding to the three gamuts of reproducible colors shown in FIG. 7. Both the gamut of reproducible colors and the maximum brightness that can be displayed vary depending on the size of the intensity differences in the emission ratio of the light emitters in each subframe differ. As the differences in the emission ratio increase, the gamut of reproducible colors widens, but the maximum brightness is reduced. As the differences in the emission ratio decrease, that is, as the emission ratio approaches a unity ratio (1:1:1), the gamut of reproducible colors narrows, but the maximum brightness increases.

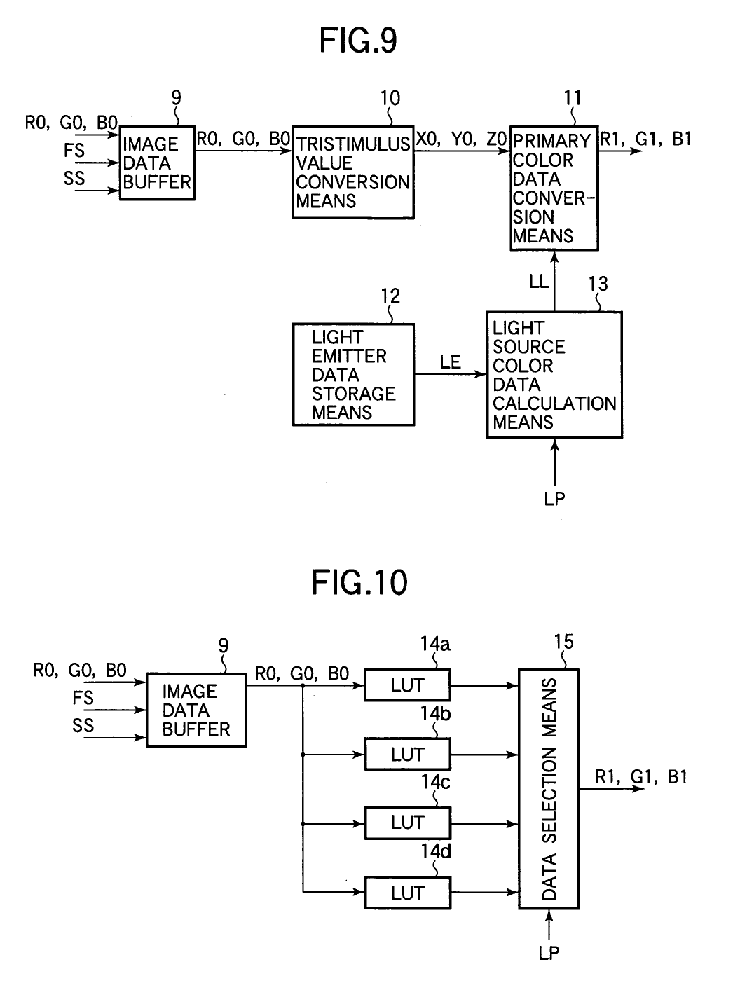

Referring to FIG. 9, the subframe image data generating means 1 comprises an image data buffer 9, a tristimulus value conversion means 10, a primary color data conversion means 11, a light emitter data storage means 12, and a light source color data calculation means 13. The image data buffer 9 receives the input image data R0, G0, and B0, frame synchronization signal FS, and subframe synchronization signal SS; the input image data are written into the image data buffer 9 in synchronization with the frame synchronization signal FS, and read therefrom in synchronization with the subframe synchronization signal SS. The tristimulus value conversion means 10 converts the input image data R0, G0, B0 read in synchronization with the subframe synchronization signal SS into tristimulus values X0, Y0, Z0 in the CIE XYZ color system. The conversion to tristimulus values is carried out according to the saturation characteristics of the color space of the input image data.

The light emitter data storage means 12 stores the saturation characteristics of the three light emitters in the light source 4 as light emitter data LE. The stored saturation characteristics include, for example, the tristimulus values of the color displayed when each light emitter is individually turned on. From the light emitter data LE and emission ratio information LP, the light source color data calculation means 13 estimates the tristimulus values of the color of the light emitted from the light source 4 in each subframe, and supplies these values to the primary color data conversion means 11 as light source color data LL. The tristimulus values obtained by the light source color data calculation means 13 in each subframe become estimated tristimulus values of the primary colors in the present image display apparatus. Using the tristimulus value information supplied from the light source color data calculation means 13 in each subframe, the primary color data conversion means 11 generates the subframe image data R1, G1, B1, which give the primary color data for each subframe, from the tristimulus values X0, Y0, Z0 output from the tristimulus value conversion means 10 in correspondence to the input image data. The subframe image data R1, G1, B1 are thus properly generated so as to match the chromaticity of the light from the light source in each subframe.

The subframe image data generating means 1 may also be structured as in FIG. 10, comprising an image data buffer 9, lookup tables (LUT) 14a to 14d, and a data selection means 15. The image data buffer 9 operates as in FIG. 9. Each of the lookup tables 14a to 14d stores combinations of subframe image data R1, G1, B1 corresponding to every possible combination of input image data R0, G0, B0, for a particular emission ratio of the light emitters. The lookup tables 14a to 14d output four different sets of subframe image data R1, G1, B1 corresponding to the same input image data R0, G0, B0. The data selection means 15 selects and outputs one of these sets of subframe image data according to the emission ratio information LP. The image display apparatus in the present embodiment displays an image by the operations described above.

In conventional image display apparatus, the relationship between the gamut of reproducible colors and the maximum displayable brightness is determined when the light source or light emitters are selected. If an image display with high brightness is required, a light source or light emitters with high brightness are selected, even though their color purity may be poor; if an image display with high saturation (a wide gamut of colors) is required, a light source or light emitters with high color purity are selected, even though their brightness may be low. After the light source or light emitters are selected and built into the image display apparatus, the relationship between the gamut of reproducible colors and the maximum brightness to be displayed is fixed and cannot easily be changed. In contrast, according to the image display apparatus of the embodiment, in which the emission ratio of the light emitters in each subframe is controlled with reference to the control information LC so as to appropriately control the spectral distribution of the light from the light source, the balance between maximum brightness and the gamut of reproducible colors in the image display can be flexibly adjusted and the color image can be displayed with an appropriate balance. Further, appropriate subframe image data are generated according to the emission ratio of the light emitters in each subframe, that is, according to the spectral distribution of the light from the light source, thereby enabling the image to be displayed with high definition (appropriate color and brightness for each pixel).

When the input image data do not include colors with high saturation, for example, a wide gamut of reproducible colors is not necessary in the image display. In this case, the control information LC reduces the differences in the emission ratio of the light emitters in each subframe so that the image can be displayed with high brightness. In contrast, when input image data include many highly saturated colors, a wide gamut of reproducible colors is necessary. In this case, the control information LC instructs the emission ratio control means 2 to increase the differences in the emission ratio of the light emitters in each subframe so that, although the maximum display brightness is lowered, an image with a wide range of colors, taken from a wide gamut of reproducible colors, can be displayed. When the main purpose is to display text data, for example, high brightness is usually more desirable than a wide gamut of colors. Control information LC that instructs the emission ratio control means 2 to reduce the differences in the emission ratio of the light emitters in each subframe (by bringing the emission ratio closer to unity) is therefore generated so that, although the gamut of reproducible colors is reduced, the image can be displayed with high brightness. A further effect of reducing the differences among the emission ratio of the light emitters in each subframe is that, since the color differences of the light source between subframes is also reduced, the undesired color breakup phenomenon that sometimes becomes visible in a field-sequential displays is also reduced.

### Second Embodiment

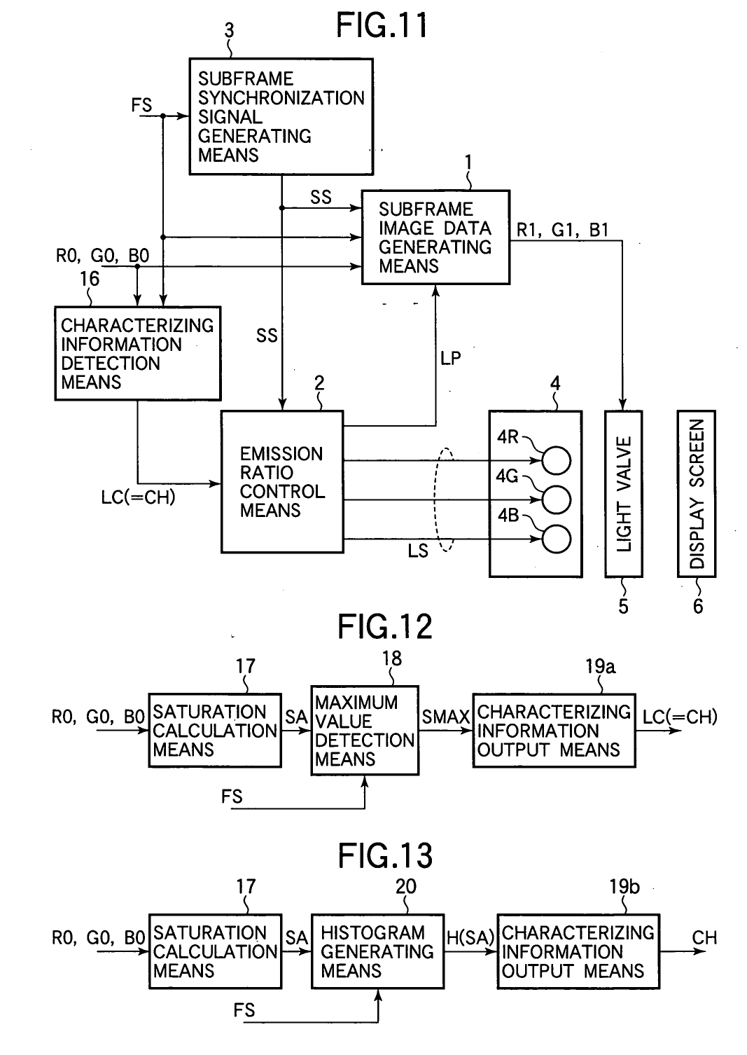

Referring to FIG. 11, the second embodiment is an image display apparatus comprising a subframe image data generating means 1, an emission ratio control means 2, a subframe synchronization signal generating means 3, a light source 4, a light valve 5, and a characterizing information detection means 16. The light source 4 comprises three light emitters 4R, 4G, 4B. The image display apparatus in the second embodiment uses characterizing information or data CH output from the characterizing information detection means 16 as the control information LC which is input to the emission ratio control means 2. The characterizing information detection means 16 generates the characterizing information CH by analyzing the input image data. The characterizing information CH indicates, for example, the distribution of pixel saturation or brightness values.

The characterizing information detection means 16 shown in FIG. 12 comprises a saturation calculation means 17, a maximum value detection means 18, and a characterizing information output means 19a. The saturation calculation means 17 receives the input image data R0, G0, B0 and calculates saturation information SA indicating the saturation of the relevant image data on a pixel-by-pixel basis. The saturation information SA can be generated using the maximum and minimum values of the input image data R0, G0, B0; the generated saturation information SA is input to the maximum value detection means 18. Referring to the frame synchronization signal FS, the maximum value detection means 18 detects a frame-by-frame maximum saturation value SMAX, giving the maximum saturation value in each frame, and supplies it to the characterizing information output means 19a. The characterizing information output means 19a generates and outputs the characterizing information CH on the basis of the maximum saturation value of a recent input frame or the maximum saturation values of a plurality of frames input in the past. For example, the characterizing information CH may be calculated from a weighted average of the maximum saturation values of the past ten frames. Except for the characterizing information detection means 16, the second embodiment has the same structure as the first embodiment described above, so detailed descriptions of the other elements will be omitted.

When the characterizing information detection means 16 has the structure shown in FIG. 12, information associated with the maximum saturation in the input image data of several recent frames (two to nine frames) is generated as the characterizing information CH. Using this information, the emission ratio control means 2 determines the emission ratio of the light emitters 4R, 4G, 4B. When, for example, the characterizing information CH indicates that the maximum saturation in the input image data is comparatively low, the emission ratio control means 2 reduces the differences in the emission ratio. That is, as the maximum saturation moves toward zero, the emission ratio moves toward a unity ratio. The displayable maximum brightness thereby becomes higher, although highly saturated colors cannot be displayed. Since the maximum saturation of the input image data is low, the inability to display highly saturated colors causes no particular problem. In contrast, when the maximum saturation in the input image data is high, the emission ratio is determined so as to increase the intensity differences of the emitters, thereby enabling highly saturated colors to be displayed.

Referring to FIG. 13, an alternative internal structure of the characterizing information detection means 16 comprises a saturation calculation means 17, a histogram generating means 20, and a characterizing information output means 19b. The saturation calculation means 17 calculates, as in FIG. 12, saturation information SA indicating the saturation of the input image data on a pixel-by-pixel basis. The generated saturation information SA is input to the histogram generating means 20. The histogram generating means 20, which also refers to the frame synchronization signal FS, generates a histogram H(SA) indicating the saturation distribution in each frame, and outputs the histogram H(SA) to the characterizing information output means 19b. The characterizing information output means 19b generates and outputs the characterizing information CH using the histogram of a recent input frame or the histograms of a plurality of frames input in the past. To calculate a histogram of a recent input frame, for example, the input image data are compared with predetermined saturation threshold values that divide the saturation scale into a plurality of ranges, and the range results are calculated as the characterizing information CH. One conceivable method is to detect ranges with pixel frequencies greater than a predetermined threshold value from the histogram and quantize the results to place the saturation distribution in one of a plurality of categories. An alternative method is to calculate the characterizing information CH of a frame, for example, by setting a predetermined threshold value for the cumulative frequency of its histogram; specifically, in the histogram, the cumulative frequency is calculated in the order of descending saturation level and the saturation value at which the cumulative frequency exceeds a predetermined threshold value is defined as the characterizing information CH.

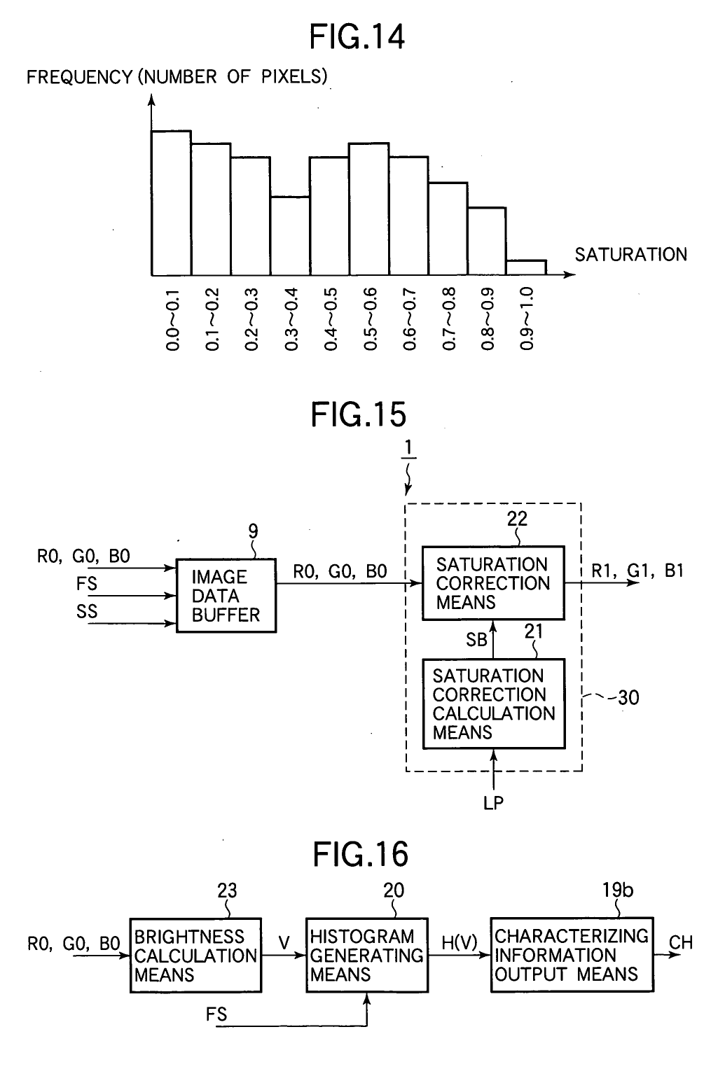

FIG. 14 is a graph showing an exemplary histogram H(SA) generated by the histogram generating means 20, the horizontal axis indicating the saturation ranges of the input image data and the vertical axis indicating the frequency (the number of pixels) in each saturation range. The characterizing information output means 19b detects, for example, the total number of pixels that exceed a saturation threshold value SA1. As the detected total number of pixels increases, the characterizing information output means 19b characterizes the input image data as having higher saturation.

When the characterizing information detection means 16 has the structure shown in FIG. 13, the emission ratio control means 2 uses the histogram-based characterizing information CH to determine the emission ratio of the light emitters 4R, 4G, 4B. As the saturation of the input image data is characterized as being lower, the emission ratio control means 2 reduces the differences in the emission ratio. As the saturation of the input image data is characterized as being higher, the emission ratio control means 2 increases the differences in the emission ratio.

Referring to FIG. 15, the subframe image data generating means 1 comprises an image data buffer 9, a saturation correction calculation means 21, and a saturation correction means 22. The image data buffer 9 operates as in FIG. 9 in the first embodiment. The saturation correction calculation means 21 receives the emission ratio information LP and refers thereto to determine a saturation correction SB for the input image data. According to the emission ratio information LP, as the differences in the emission ratio of the light emitters decrease, the saturation correction calculation means 21 generates a saturation correction SB that increasingly enhances the saturation of colors in the input image data. Alternatively, as the differences in the emission ratio of the light emitters increase, the saturation correction calculation means 21 generates a saturation correction SB that increasingly reduces the saturation of colors in the input image data.

The saturation correction calculation means 21 and saturation correction means 22 constitute a saturation adjustment means 30 for adjusting the saturation of the input image data with reference to the emission ratio given on a per-subframe basis.

Without the saturation correction, as the differences in the emission ratio of the light emitters decrease, the gamut of reproducible colors upon display narrows, so that an image with overall low saturation is displayed. The saturation correction means 22 performs a saturation correction on the image data R0, G0, B0 according to the input saturation correction SB to generate the subframe image data R1, G1, B1. The saturation correction in the saturation correction means 22 is performed by adjusting the ratio of the achromatic component included in the image data.

Referring to FIG. 16, another exemplary internal structure of the characterizing information detection means 16 is obtained by replacing the saturation calculation means 17 in FIG. 13 with a brightness calculation means 23. The characterizing information detection means 16 in FIG. 16 now generates a histogram of the brightness distribution in the input image data and generates and outputs the characterizing information CH from this histogram. Therefore, the output characterizing information CH used by the emission ratio control means 2 to determine the emission ratio of the light emitters indicates the brightness of the input image data. When the characterizing information CH indicates that the brightness in the input image data is low, for example, the emission ratio control means 2 increases the differences in the emission ratio. Colors with high saturation can then be displayed, though the maximum displayable brightness decreases. Since the brightness of the input image data is small, the decreased maximum brightness causes no problem. In contrast, when the characterizing information CH indicates that the brightness in the input image data is high, the emission ratio control means 2 decreases the differences in the emission ratio, bringing the emission ratio closer to unity, which leads to an increase of the maximum displayable brightness. The subframe image data generating means 1 may then be configured so as to convert the brightness levels of the input image data with reference to the emission ratio of the light emitters of the respective colors, to compensate for the varying brightness of the light source 4.

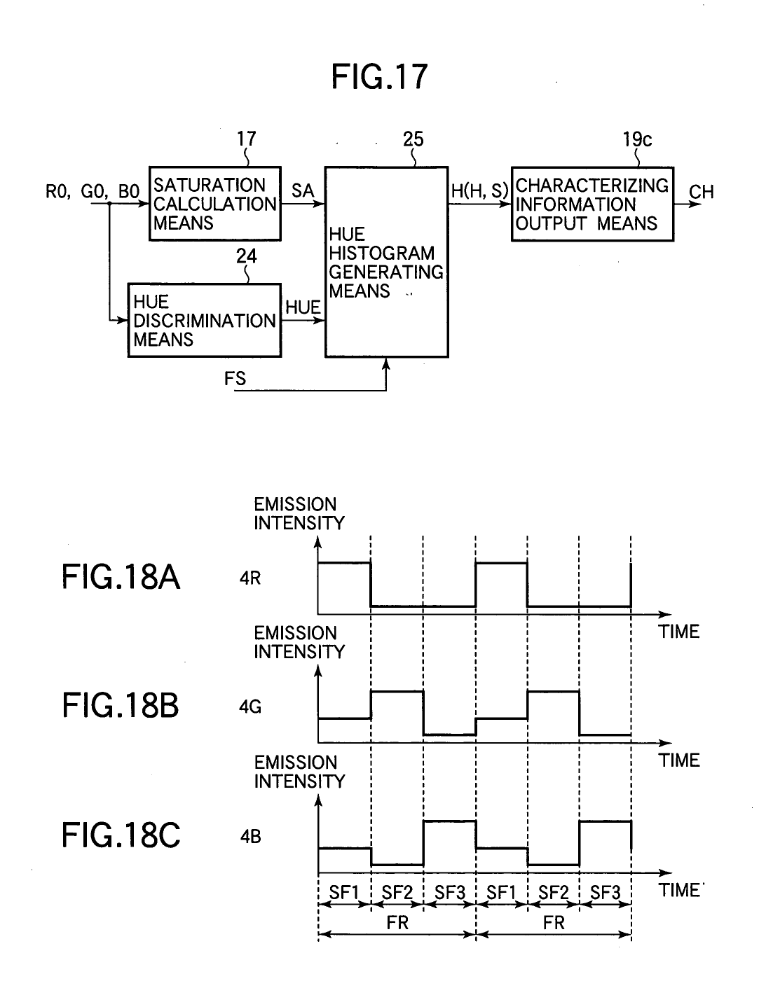

Referring to FIG. 17, yet another exemplary internal structure of the characterizing information detection means 16 further comprises a hue discrimination means 24 and generates a saturation histogram for each hue. The saturation calculation means 17 is the same as in FIG. 13; it calculates saturation information SA indicating the saturation of the input image data R0, G0, B0. The input image data R0, G0, B0 are also supplied to the hue discrimination means 24, in which hue information (HUE) indicating the hues of the input image data is calculated. The hue information can be calculated from the magnitude relations among the input image data R0, G0, B0. When the input image data are classified into red, green, and blue hues, for example, the hue of a particular pixel in the input image data can be discriminated by comparing the input R0, G0, B0 data values of the pixel and finding which one is the greatest. The saturation information SA and hue information HUE are input to a hue histogram generating means 25.

The hue histogram generating means 25 generates a histogram H(H, S) of the saturation information SA for each hue indicated by the hue information HUE. Therefore, the generated histograms include, for example, saturation histograms individually generated for pixels of generally red, green, and blue hues in the image. A characterizing information output means 19c generates characterizing information CH using the saturation histograms H(H, S) individually generated for each hue. The generated characterizing information CH indicates the ratio of inclusion of highly saturated colors of each hue. Using this information, the emission ratio control means 2 determines the emission ratio of the light emitters in each subframe. FIGS. 18A to 18C are graphs showing exemplary emission intensities of the light emitters 4R, 4G, 4B in each subframe, the vertical axis indicating the emission intensity of a light emitter and the horizontal axis indicating time. FIGS. 18A to 18C show exemplary emission intensities of the light emitters when the red hues include few highly saturated colors. In the subframe (subframe SF1) in which the light emitter 4R has the greatest intensity, the other light emitters 4G, 4B also have fairly large emission intensities. Red hues therefore cannot be displayed with high saturation, but the maximum displayable brightness increases. In subframe SF1, the emission intensities of light emitters 4G, 4B need not be mutually equal.

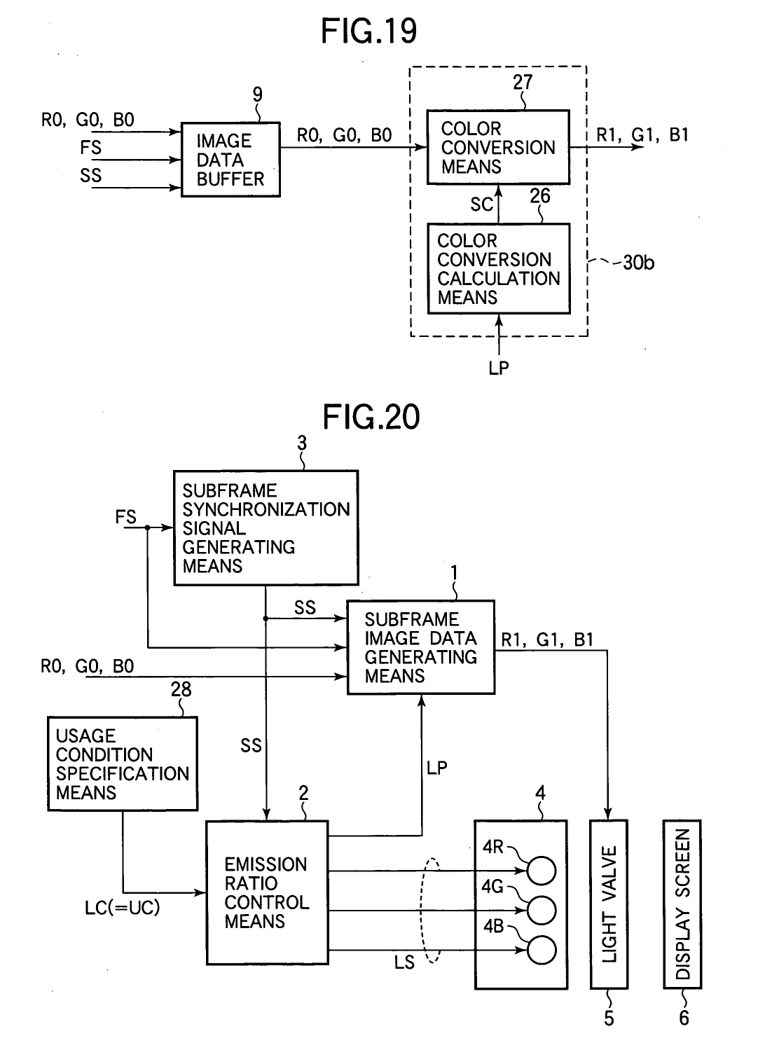

Referring to FIG. 19, the subframe image data generating means 1 comprises an image data buffer 9, a color conversion calculation means 26, and a color conversion means 27. The image data buffer 9 operates as in FIG. 9 in the first embodiment. The color conversion means 27 performs a color conversion on the input image data output from the image data buffer 9 according to a color conversion parameter SC output from the color conversion calculation means 26 to generate the subframe image data R1, G1, B1. The color conversion performed in the color conversion means 27 may be any conversion capable of providing varying amounts of saturation adjustment for each hue indicated by the input image data. The color conversion calculation means 26 receives and refers to the emission ratio information LP to determine the color conversion parameter SC for the input image data. If the emission ratio information LP indicates a low-difference emission ratio in red subframes, for example, the color conversion calculation means 26 generates a color conversion parameter SC that increases the saturation of red. If the emission ratio information LP indicates a high-difference emission ratio in red subframes, the color conversion calculation means 26 generates a color conversion parameter SC that decreases the saturation of red.

The color conversion calculation means 26 and color conversion means 27 constitute a saturation adjustment means 30b for adjusting the saturation of colors in the input image data with reference to the emission ratio given on a per-subframe basis.

According to the image display apparatus of the second embodiment, information CH characterizing the input image data is detected, and the emission ratio of the light emitters in each subframe is controlled with reference to the detected result, that is, the spectral distribution of the light emitted from the light source is appropriately controlled. The balance between maximum brightness and the gamut of reproducible colors in the image display is thereby appropriately adjusted according to the input image data, obtaining a color image display with an appropriate balance. Further, appropriate subframe image data are generated according to the emission ratio of the light emitters in each subframe, that is, according to the spectral distribution of the light from the light source, thereby enabling the image to be displayed with high definition (appropriate color and brightness for each pixel).

### Third Embodiment

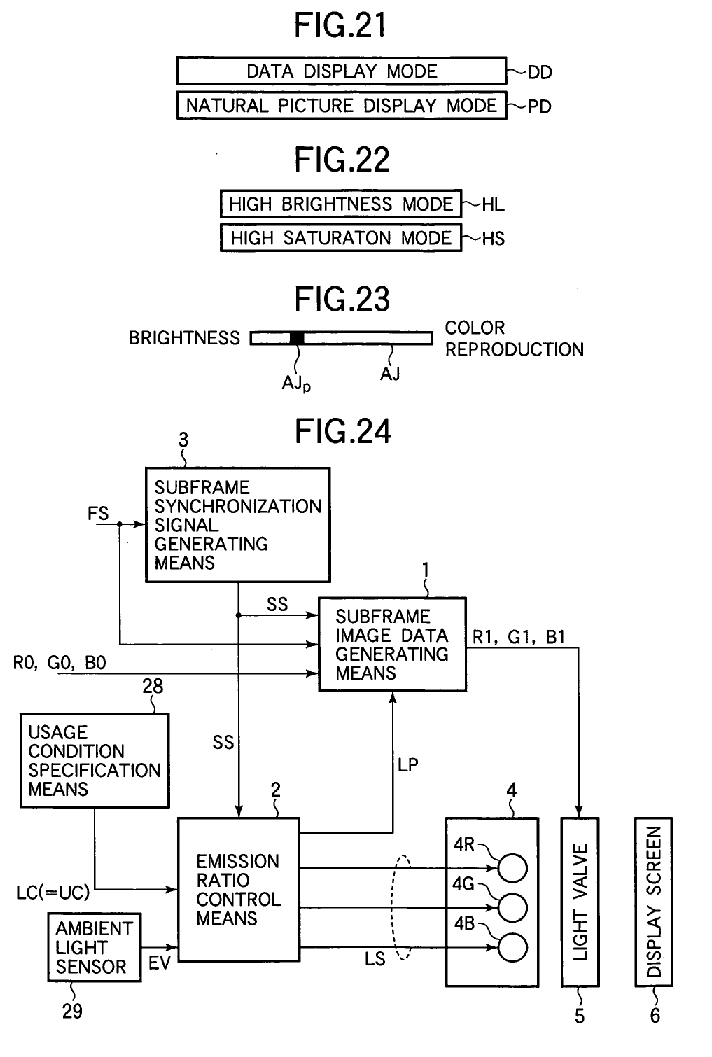

Referring to FIG. 20, the third embodiment is an image display apparatus comprising a subframe image data generating means 1, an emission ratio control means 2, a subframe synchronization signal generating means 3, a light source 4, a light valve 5, and a usage condition specification means 28. The light source 4 comprises three light emitters 4R, 4G, 4B. The image display apparatus of the present embodiment employs usage condition data UC output from the usage condition specification means 28 as the control information LC input to the emission ratio control means 2. The usage condition specification means 28 is used by the user to specify conditions of usage, and outputs the specified results as the usage condition data UC. The usage conditions specified by the user may include, for example, the purpose of use and the usage environment. FIG. 21 shows an exemplary graphical user interface (GUI) in the usage condition specification means 28. The interface in FIG. 21 has menu buttons DD, PD that are operated by the user with a pointing device to select, according to the purpose of use, an appropriate mode from among two display modes: a data display mode and a natural picture display mode.

The data display mode is selected when the image display apparatus is used mainly to display text data or chart data; the natural picture display mode is selected when the image display apparatus is used mainly to display video or still-picture images. The usage condition specification means 28 generates the usage condition data UC according to the user's selection. When the data display mode is selected, for example, usage condition data UC are generated indicating that maximum brightness is more important than the gamut of reproducible colors. When the natural picture display mode is selected, usage condition data UC are generated indicating that the gamut of reproducible colors is more important than maximum brightness. The emission ratio control means 2 determines the emission ratio of the light emitters with reference to the usage condition data UC output from the usage condition specification means 28. The exemplary menu shown in FIG. 21 can be configured so as to be displayed on the display screen 6 of the image display apparatus by a predetermined operation. Alternatively, the image display apparatus may be equipped with a separate display screen (not shown) dedicated to the menu display, in addition to the image display screen 6.

FIG. 22 shows another exemplary menu allowing the user to specify usage conditions in the usage condition specification means 28. In FIG. 22, the buttons HL, HS are operated by the user to select an appropriate mode according to the purpose of use or the usage environment from the following two display modes: a high brightness mode and a high saturation mode. When the high brightness mode is selected, the usage condition specification means 28 generates usage condition data UC indicating that maximum brightness is more important than the gamut of reproducible colors. When the high saturation mode is selected, the usage condition specification means 28 generates usage condition data UC indicating that the gamut of reproducible colors is more important than maximum brightness. FIG. 23 shows yet another exemplary means that may be used by the user to specify usage conditions in the usage condition specification means 28; this means is an adjustment bar AJ, a type of graphical user interface operated by the user to select the balance between the gamut of reproducible colors and maximum brightness in a continuous fashion according to the purpose of use or the usage environment. The user specifies the balance between the gamut of reproducible colors and maximum brightness in the image display by sliding the selection position AJp of the adjustment bar AJ. The usage condition specification means 28 generates usage condition data UC indicating the importance of the gamut of reproducible colors according to the specified position. As the importance of the gamut of reproducible colors increases, the importance of maximum brightness decreases. The emission ratio control means 2 determines the emission ratio of the light emitters with reference to the importance of the gamut of reproducible colors indicated by the usage condition data UC output from the usage condition specification means 28.

According to the image display apparatus of the present embodiment, the emission ratio of the light emitters in each subframe is controlled with reference to the usage conditions specified by the user according to the purpose of use or the environment of use, that is, the spectral distribution of the light from the light source is appropriately controlled. The balance between maximum brightness and the gamut of reproducible colors in the image display is thereby appropriately adjusted according to the usage conditions, and the color image is displayed with an appropriate balance. Further, appropriate subframe image data are generated according to the emission ratio of the light emitters in each subframe, that is, according to the spectral distribution of the light from the light source, thereby enabling the image to be displayed with high definition (appropriate color and brightness for each pixel).

### Fourth Embodiment

Referring to FIG. 24, the fourth embodiment is an image display apparatus that adds an ambient light sensor 29 to the third embodiment above. The ambient light sensor 29 detects the light level around the image display apparatus and supplies the detected result to the emission ratio control means 2 as ambient light data EV. The usage condition specification means 28 displays, for example, the menu shown in FIG. 22 in the third embodiment, allowing the user to select either the high brightness mode or the high saturation mode. The usage condition specification means 28 supplies the user's selection to the emission ratio control means 2 as the usage condition data UC.

The emission ratio control means 2 determines the emission ratio of the light emitters from the ambient light data EV and usage condition data UC. This operation is performed, for example, as follows.

When the usage condition data UC indicate that the high brightness mode is selected, as the ambient light data EV indicates increasingly bright ambient lighting, the emission ratio control means 2 reduces the differences in the emission ratio of the light emitters. As a result, the maximum brightness of the image display increases, so that good visibility is maintained despite the bright ambient lighting. Under dark ambient lighting, user eyestrain caused by unnecessarily high displayed brightness is prevented.

When the usage condition data UC indicate that the high saturation mode is selected, as the ambient light data EV indicates increasingly bright ambient lighting, the emission ratio control means 2 increases the differences in the emission ratio of the light emitters. As a result, the gamut of reproducible colors in the image display is widened, thereby maintaining good color reproduction despite the bright ambient lighting. There is a general tendency for colors displayed by image display apparatus to appear washed out under bright ambient light; the image display apparatus of the present embodiment can compensate for this tendency.

As described above, the image display apparatus of the present embodiment additionally refers to ambient light conditions, so that color images can be displayed with an appropriate balance between maximum brightness and the gamut of reproducible colors.

The invention is not limited to the preceding embodiments. Those skilled in the art will recognize that many further variations are possible within the scope of the invention, which is defined by the appended claims.

What is claimed is:

1. An image display apparatus that divides each frame of an image into a plurality of subframes, comprising:
a light source operable to generate light of different spectral distributions for the different subframes constituting a frame;
a subframe image data generating unit configured to receive input image data and to generate subframe image data corresponding to the spectral distribution of each subframe;
a light valve modulating the light generated by the light source pixel-wise according to the subframe image data; and
a control unit configured to receive control information and controlling the spectral distributions of the light generated by the light source in each subframe.

2. The image displaying apparatus of claim 1, wherein:
the light source comprises a plurality of light emitters emitting light of different colors at intensities according to an emission ratio provided in each subframe;
the control unit controls the emission ratio in each subframe with reference to the control information; and
the subframe image data generating unit generates the subframe data with reference to the emission ratio.

3. The image displaying apparatus of claim 2, wherein the subframe image data generating unit uses the emission ratio supplied in each subframe to estimate a color of the light from the light source in each subframe and generates the subframe image data according to the estimated color.

4. The image displaying apparatus of claim 2, wherein the subframe image data generating unit has a saturation adjustment unit that refers to the emission ratio supplied in each frame and adjusts the saturation of the input image data.

5. The image displaying apparatus of claim 4, wherein the saturation adjustment unit processes the input image data to improve color saturation as the emission ratio approaches a unity ratio.

6. The image displaying apparatus of claim 2, further comprising a characterizing information output unit that detects characterizing information in the input image data, wherein
the control unit controls the emission ratio by using the characterizing information detected by the characterizing information output unit as said control information.

7. The image displaying apparatus of claim 6, wherein the characterizing information includes a saturation value of the input image data.

8. The image displaying apparatus of claim 7, wherein the control unit controls the emission ratio so that the emission ratio approaches a unity ratio as the saturation value of the input image data decreases.

9. The image displaying apparatus of claim 6, wherein the characterizing information includes a brightness value of the input image data.

10. The image displaying apparatus of claim 9, wherein the control unit controls the emission ratio so that the emission ratio approaches a unity ratio as the brightness of the input image data increases.

11. The image displaying apparatus of claim 2, further comprising a usage condition specification unit configured to specify conditions of usage relating to ambient environment and purpose of use, wherein the control unit uses the conditions of usage specified by the usage condition specification unit as said control information.
